(19) United States
(12) Patent Application Publication
(10) Pub. No.: US 2024/0253011 A1
(43) Pub. Date: Aug. 1, 2024

(54) Carbon-based nanoparticles for PFAS remediation

(71) Applicants: Regents of the University of Minnesota, Minneapolis, MN (US); The Connecticut Agricultural Experiment Station, New Haven, CT (US)

(72) Inventors: Christy Haynes, Minneapolis, MN (US); Riley Lewis, St. Paul, MN (US); Cheng-Hsin Huang, Minneapolis, MN (US); Sara Nason, North Haven, CT (US); Nubia Zuverza-Mena, Hamden, CT (US); Jason White, Prospect, CT (US)

(21) Appl. No.: 18/430,265

(22) Filed: Feb. 1, 2024

Related U.S. Application Data
(60) Provisional application No. 63/442,596, filed on Feb. 1, 2023.

(51) Int. Cl. B01J 20/20; B01J 20/28; B01J 20/30; C01B 32/318; C01B 32/342; B09C 1/08

(52) U.S. Cl. CPC B01J 20/205; B01J 20/28007; B01J 20/3078; C01B 32/318; C01B 32/342; B09C 1/08; B09C 2101/00; C01P 2004/64

(57) ABSTRACT

A method of producing nanoscale carbon dots suitable for uptake by a plant and with increased affinity to Per- and poly-fluoroalkyl substances wherein the nanoscale carbon dots are synthesized through a hydrothermal reaction of branched polyethyleneimine and citric acid producing polyethyleneimine-based carbon dots.

### CROSS-REFERENCE TO RELATED APPLICATION

The present application is based on and claims the benefit of U.S. provisional patent application Ser. No. 63/442,596, filed Feb. 1, 2023, the content of which is hereby incorporated by reference in its entirety.

### GOVERNMENT LICENSE RIGHTS

This invention was made with government support under ES032712 awarded by the National Institutes of Health. The government has certain rights in the invention.

### FIELD OF THE INVENTION

This disclosure relates to the phytoremediation of Per- and poly-fluoroalkyl substances (PFAS) and specifically to the use of nanoscale carbon dots suitable for uptake by a plant and with increased affinity to Per- and poly-fluoroalkyl substances to uptake PFAS from soil.

### BACKGROUND

PFAS are a large family of highly fluorinated compounds. Since their first appearance in the 1950s, more than 7,500 PFAS have been developed for industrial use. However, concerns about the use of PFAS have been raised because of their bioaccumulation and potential health risks. Despite restrictions set forth to control PFAS usage, there is still a need to develop remediation methods for existing contamination. The high mobility and stability of PFAS prevent their natural degradation and make remediation efforts challenging. Previous research has established that plants can uptake PFAS from contaminated soil and water, suggesting that phytoremediation can be an effective remediation method for PFAS. However, while shorter chain length PFAS can translocate to above-ground plant tissue, longer chain PFAS tend to accumulate in the roots, which is not ideal. Therefore, improvements need to be made to enhance the translocation of longer chain PFAS for the complete removal from the contaminated site.

PFAS are a family of synthetic organofluorine compounds with at least one fully fluorinated carbon atom. PFAS have useful chemical and physical properties including amphiphilicity, resistance to oxidation, and high thermal stability; thus, thousands of PFAS have been developed and widely incorporated into various industrial products such as firefighting foams, food packaging, and nonstick cookware. However, the widespread application of PFAS has led to the contamination of soil and groundwater all over the world. Experiments showed that PFAS are toxic to animals and human beings, and the persistence of PFAS make them easy to bioaccumulate through food chains. This potential risk has drawn great attention resulting in the emergence of regulations for the use of PFAS across the world. Due to the wide distribution of PFAS contamination in global environments and the continued production and use of PFAS, efficient and cost-effective PFAS remediation methods need to be developed to reduce the associated risks.

Current common technologies for PFAS remediation include activated carbon treatment, ion exchange resins, and thermal desorption. However, these methods are often ineffective or expensive. Additionally, most of the existing methods are for water treatment, and few of them can be adapted and applied to soil contaminants. Therefore, there is a critical need to develop an efficient and cost-effective method to remove PFAS from soil.

Previous studies have shown that some plant species, such as hemp, have the ability to accumulate PFAS; therefore, phytoremediation, the use of plants to extract contaminants, is a potential technology that could aid in the removal of PFAS from the soil. Furthermore, harvest of the plants completely removes the contaminants from the site for thermal destruction. However, plant uptake of PFAS is highly dependent on the chain length of PFAS. Shorter chain length PFAS can easily translocate to the above-ground plant tissue to be harvested, while longer chain length PFAS tend to accumulate in the roots and are harder to be harvested. Given that contamination sites usually contain a mixture of PFAS with different chain lengths, improvements are needed to enhance the phytoremediation of PFAS.

### SUMMARY

This disclosure describes a method of producing nanoscale carbon dots for use by a plant to produce increased affinity by the plant for anionic per- and poly-fluoroalkyl substances where in the method comprises synthesizing the nanoscale carbon dots through a hydrothermal reaction of branched polyethyleneimine and citric acid in a microwave reactor producing polyethyleneimine-based carbon dots.

In another embodiment this disclosure describes wherein the nanoscale carbon dots are synthesized with chitosan, lysine, and an acid.

In another embodiment this disclosure describes wherein the acid comprises HCl, malic acid, citric acid, or acetic acid or any combination thereof.

In another embodiment this disclosure describes wherein the ratio of chitosan and acid to lysine is selected to obtain the highest affinity to the Per- and poly-fluoroalkyl substances.

In another embodiment this disclosure describes wherein the nanoscale carbon dots were synthesized with chitosan, lysine, and acid in weight ratios of approximately 1:1:1 or 5:1:5 or 10:1:10 or 20:1:20.

In another embodiment this disclosure describes wherein the nanoscale carbon dots were synthesized in a microwave reactor.

In another embodiment this disclosure describes wherein the nanoscale carbon dots were synthesized at a temperature range of approximately 150-200° C.

In another embodiment this disclosure describes wherein the nanoscale carbon dots were synthesized from about 30 minutes to 2 hours.

In another embodiment this disclosure describes wherein the nanoscale carbon dots were synthesized under reflux for about 24-48 hours.

In a further aspect the polyethyleneimine-based carbon dot with increased affinity for per- and poly-fluoroalkyl substances was produced through a hydrothermal reaction of branched polyethyleneimine and citric acid producing polyethyleneimine-based carbon dots.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A is a schematic of PEI-CD synthesis and PFAS exposure experiments.

FIG. 1B is a graphical view of representative dynamic light scattering (DLS) data for PEI-CDs before and after exposure to perfluorooctanoic acid (PFOA).

FIG. 2 is a fluorescence spectra (λₑₓ=350 nm) of PEI-CDs with varying concentrations of PFOA. Inset shows minimal differences in emission maxima or intensity.

FIG. 3 is a ¹⁹F NMR spectra of 5 mg/L PFOA with increasing concentrations of PEI-CDs after 72 hours of mixing. Dashed lines are included to show changes in chemical shift from the PFOA control, and each peak is labeled to correspond with the fluorine atoms labeled on the PFOA structure as shown in FIG. 5A.

FIG. 4 is a visual representation of how the PFOA solution is changing with increasing PEI-CD concentration based on the changes to NMR spectra. The blue and red rods represent PFOA, and the yellow circles represent PEI-CDs.

FIG. 5A is labeled perfluorooctanoic acid (PFOA) molecule, indicating the fluorine atoms responsible for NMR features in FIG. 3.

FIG. 5B is a table showing the maximum change in chemical shift for each PFOA peak across the range of PEI-CD concentrations used in FIG. 3.

FIG. 5C is the binding curve generated from the average height of all peaks in the first seven spectra of FIG. 3.

FIG. 6A is selected ¹⁹F NMR spectra of PFOA at different timepoints after exposure to 100 mg/L of PEI-CDs.

FIG. 6B is corresponding change in peak integration at all time points compared to that without PEI-CDs for the CF₃ peak at −80.7 ppm and α-fluorine at −117.4 ppm. Inset shows a magnified version of the 2 h-168 h timepoints. The 72 h timepoint is noted with a vertical dashed line as that is when all other ¹⁹F NMR and characterization were conducted.

FIG. 7 is general peak assignments for 24-PFAS mixture.

FIG. 8A is ¹⁹F NMR spectra of a 24-PFAS mixture with each component at 5 mg/L and increasing amounts of PEI-CDs.

FIG. 8B is general structure corresponding to the different regions identified in FIG. 7.

FIG. 8C percent difference in integration between the mixture control and incubation with 10 g/L PEI-CDs for the spectral regions and structural elements highlighted.

FIG. 9 is a graphical view of 19F NMR results of a quick check of various chitosan-based CD species showing all the CDs reduce PFOA signal in comparison to the control.

FIG. 10 is a graphical view of changes in 19F NMR of PFOA with the addition of chitosan, lysine, and malic acid 1:1:1 CDs (left) and resulting binding curve from the changes in intensity (right).

### DETAILED DESCRIPTION

Carbon dots (CDs) are a broad class of nanomaterial with great potential as a PFAS sorbent based on their use of inexpensive precursors, tunable surface chemistry, and facile synthesis. Within the category of CDs, there are graphene quantum dots, carbon quantum dots, and amorphous/polymeric carbon dots; amorphous/polymeric CDs have the advantages that they are frequently synthesized at low temperatures and can be synthesized from a range of polymer and small molecule precursors. Synthesis from a range of precursors facilitates a wide array of applications taking advantage of chemical affinity for various compounds, which can be readily extended to PFAS. The precursors used in CD synthesis can be carefully chosen to incorporate hydrophobic pockets and functional groups that promote electrostatic interactions. As noted, there is an urgent need to design materials that effectively sorb PFAS in a cost-efficient manner and allow investigations into the interactions that drive PFAS sorption. The range of CD synthetic precursors and potential for functionalization provide an excellent platform to further understand PFAS sorption while developing cost-effective remediation materials.

Assessing the effectiveness of PFAS sorbent materials is typically done using LC-MS methods and requires separation between the sorbent material and excess PFAS in solution. This is frequently done through centrifugation and analyzing remaining free PFAS in the supernatant. However, CDs do not readily centrifuge out of solution. Other sample cleanup methods like Cis and SPE sorbents are not effective for recovering all PFAS and introduce potential points for systematic biases from sample preparation. Fluorine nuclear magnetic resonance spectroscopy (¹⁹F NMR) is an attractive alternative to assess CD uptake of PFAS that is nondisruptive and requires no centrifugation, chemical treatment, or other complex sample preparation steps. In this case, NMR analysis is possible because the carbon dot suspensions maintain colloidal stability even at high concentrations.

Fluorine NMR peak intensity and chemical shifts are very sensitive to changes in the molecular environment surrounding the fluorine atoms. As a result, chemical shift perturbations and changes in peak intensity are frequently used to identify ligand-protein binding events and quantify interactions. Titration experiments can reveal additional information about the system such as the chemical exchange regime, which describes the rate a nucleus goes between two or more molecular environments, such as from free to bound, and provides insight into affinity. Many ¹⁹F NMR-based experiments focus on traditional biological systems; however, recent applications have expanded to include PFAS by elucidating analyte binding orientations, assessing degradation, and quantification of total PFAS in environmental samples. To our best knowledge ¹⁹F NMR has not been used to quantify PFAS affinity for sorbent materials before this work. We can further expand ¹⁹F NMR methods to a PFAS-nanoparticle system and quantify CD affinity towards PFAS, determine chemical exchange regimes, and elucidate potential binding mechanisms that inform future sorbent design.

This disclosure provides evidence that (1) CDs are a potential effective PFAS sorbent material and (2) describes a method to probe interactions between CDs and PFAS. To do this, CDs were designed and synthesized to target anionic PFAS. This was achieved using two classes of carbon dots, polyethyleneimine (PEI)-based CDs and chitosan-based CDs, both positively charged amine-rich polymer precursors, to promote electrostatic interactions and incorporate hydrophobic pockets into the CDs. Allowing for both electrostatic and hydrophobic interactions to increase the potential for association with a wide range of PFAS and help maintain affinity even in more complex matrices. CD size and surface charge following exposure to PFOA, an anionic PFAS with environmental relevance, was tracked to provide insight into any associations occurring between CDs and PFOA. Changes in ¹⁹F NMR PFOA peak intensity and chemical shifts during a CD titration were monitored to establish a dissociation content (K_{D}), determine the chemical exchange regime, and elucidate potential binding mechanisms. Following successful association between PEI-based CDs and PFOA, we expanded to a 24 PFAS mixture to investigate PEI-based CD performance in a more complex PFAS matrix. In total, CDs have great promise as a PFAS sorbent material and that ¹⁹F NMR provides an ideal background-free method to investigate PFAS sorption with no significant sample preparation.

This disclosure further describes using the PEI-based CD and chitosan-based CD nanoparticles with PFAS affinity to enable the phytoremediation of a wider range of PFAS from contaminated sites. Several attempts have been made to enhance plant uptake of molecules using nanomaterials as carriers. The small size and relatively large surface area of nanoparticles allow them to transport small molecules and be taken up by plants. Additionally, the various physiochemical properties of nanoparticles allow them to be tuned for desired functions. Specifically, nanoscale carbon dots (CDs) have a high surface area to volume ratio that is useful for sorption of small molecules, and show affinity for PFAS. CDs are biocompatible nanoparticles, and their surfaces are highly tunable, allowing easy modification to incorporate targeting moieties. Additionally, previous studies suggested significant uptake of nanoscale carbon dots by plants. CDs have the potential to sorb PFAS and help with their delivery into plants for phytoremediation purpose. Nanoscale carbon dots made with selected precursors are suitable because of (1) their tunable surface characteristics which are suitable for PFAS uptake and (2) CDs can be taken up by and translocated within plants. The CDs will be synthesized and functionalized to enhance PFAS affinity, and thus increase the uptake of PFAS into plants when compared to uptake by the plant without the carbon dots having been synthesized with either chitosan, lysine, and an acid, and polyethyleneimine and citric acid. The CDs will be applied to plants in a hydroponic system to investigate their efficacy for phytoremediation.

This disclosure further proposes CDs as the carriers to enhance the translocation and phytoremediation of a variety of PFAS into above-ground plant tissues for removal from contamination sites. CDs will be synthesized using chitosan, lysine, and an acid (HCl, citric acid, malic acid, acetic acid) in different ratios and reaction conditions to tune the surface charge and functional groups present and optimize interactions with PFAS. Other positively charged CDs will be synthesized with polyethyleneimine and citric acid to increase ionic interactions with PFAS. The loading of four model PFAS compounds, perfluorooctane sulfonic acid (PFOS), perfluorooctanoic acid (PFOA), perfluorobutane sulfonic acid (PFBS) and undecafluoro-2-methyl-3-oxahexanoic acid (GenX), into CDs will be tested. The affinity of the different CDs for PFAS will be characterized and quantified with ¹⁹F NMR. Upon optimization of CD synthesis for PFAS attraction, the transportation and localization of PFAS and CDs will be investigated using hemp and zucchini plants in a hydroponic system. These studies will provide insights on the interaction between PFAS and CDs and their uptake by plants.

### Results and Discussion for PEI Carbon Dots

### Synthesis and Characterization of PEI Carbon Dots (PEI-CDs)

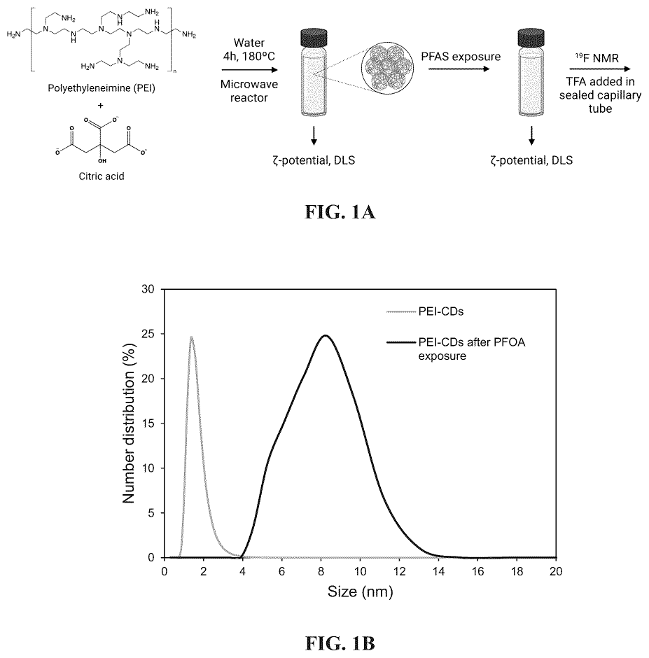

Polyethyleneimine-based carbon dots (PEI-CDs) were synthesized through a hydrothermal reaction of branched polyethyleneimine (PEI) and citric acid in a microwave at 180° C. (see FIG. 1A). It is believed that a range of 150 to 200° C. would also be acceptable. Citric acid was used as a cross-linking agent, where the carboxyl and hydroxyl groups undergo condensation reactions with the PEI amine groups. The resulting product from a standard synthesis was a translucent yellow suspension that could be lyophilized to produce −500 mg of CD product. Dynamic light scattering (DLS) indicates that PEI-CDs have an effective hydrodynamic diameter of 1.6±0.5 nm based on the number average (see FIG. 1).

In addition, ζ-potential measurements show a positive charge (+38.6±1.1 mV), which is most likely a result of using PEI, an amine-rich precursor. Fluorescence measurements indicate the excitation/emission maxima at 350 nm/445 nm. These excitation/emission wavelengths align with other PEI-based CDs, and the fluorescent nature indicates these are amorphous/polymeric carbon dots.

### PEI-CD Exposure to PFAS

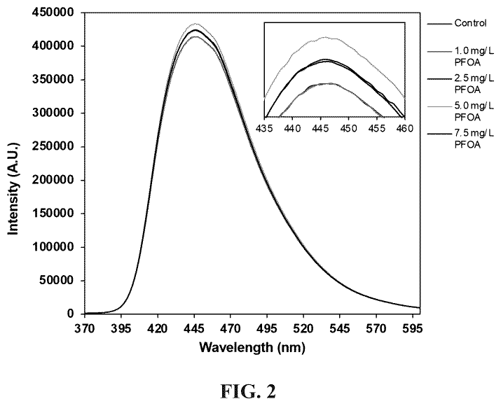

Initial experiments were conducted to assess any changes to size, charge, and the fluorescent properties of the PEI-CDs upon exposure to 5 mg/L perfluorooctanoic acid (PFOA). PFOA was chosen as the target PFAS for initial experiments based on its environmental relevance. After exposure to PFOA for 72 hours, PEI-CDs significantly increased in effective hydrodynamic diameter from 1.6±0.5 nm to 7.8±1.8 nm (Table 1). This increase is most likely a result of PFOA sorption to PEI-CDs, resulting in a larger effective size; this change in effective size could be either an actual increase in size or an increase in mass that is reported as a change in size. The ζ-potential of the PFOA-exposed PEI-CDs significantly decreased from +38.6±1.1 mV to +26.4±0.8 mV, further indicating sorption as the negatively charged PFOA molecule will mask and balance some the PEI-CD positive charge, resulting in a lower ζ-potential. Both the increase in effective size and decrease in ζ-potential of PEI-CDs in the presence of PFOA are consistent with significant analyte sorption. The fluorescent properties of the PEI-CDs did not change in a significant way following exposure to a range of PFOA concentrations. There are some slight variations in intensities between samples, however, no explicit shifts in emission maxima (FIG. 2 for Fluorescence spectra (λex=350 nm) of PEI-CDs with varying concentrations of PFOA. Inset shows minimal differences in emission maxima or intensity). As a result, PEI-CDs are not able to act as a fluorescence sensor for PFOA, but PEI-CDs could be fluorescently tracked within biological systems even after sorption.

TABLE 1
Values for hydrodynamic diameter and ζ
potential of PEI-CDs with and without PFOA present

| | | PEI-CDs | |
|---|---|---|---|
| | PEI-CDs | with PFOA | P-value |
| Hydrodynamic | 1.6 ± 0.5 | 7.8 ± 1.8 | <0.005 |
| diameter (nm) | | | |
| Z Potential | +38.6 ± 1.1 | +26.4 ± 0.8 | <0.0001 |
| (mV) | | | |

### Understanding PFOA Sorption to PEI-CDs

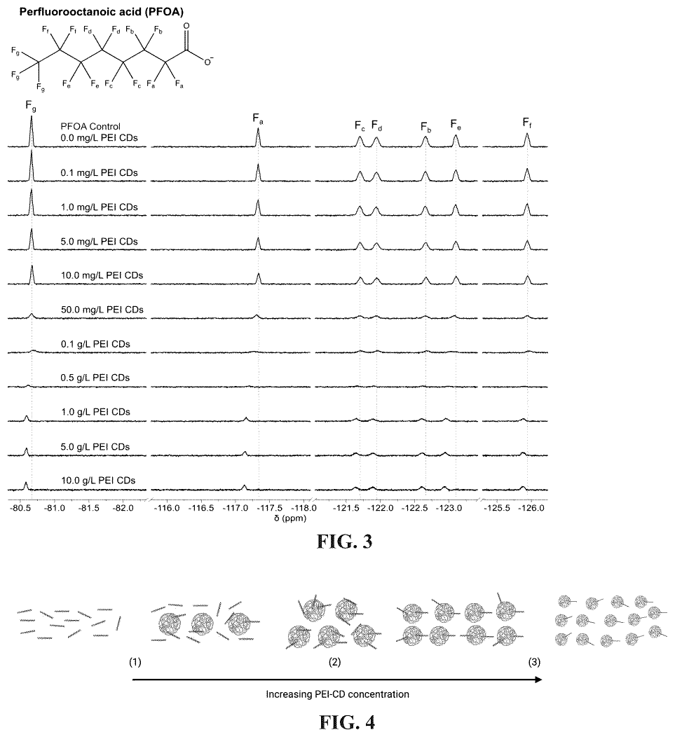

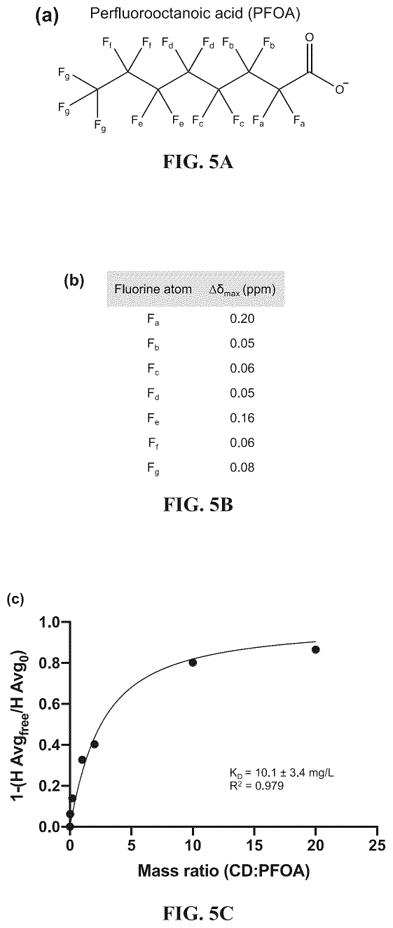

To further understand the interactions occurring between PFOA and PEI-CDs, ¹⁹F NMR spectroscopy was employed to confirm sorption, assess affinity, and elucidate additional binding information. Changes in chemical shift and peak intensity of PFOA were monitored across various PEI-CD concentrations and time points. If PFOA becomes associated with the PEI-CDs, there will be various changes to chemical shift and peak intensity because of the changing molecular environment of the fluorine in the PFOA. In this case, increasing amounts of PEI-CDs induced changes to the PFOA ¹⁹F NMR spectrum, further confirming sorption (See FIG. 3 for 19F NMR spectra of 5 mg/L PFOA with increasing concentrations of PEI-CDs after 72 hours of mixing. Dashed lines are included to show changes in chemical shift from the PFOA control, and each peak is labeled to correspond with the fluorine atoms labeled on the PFOA structure as shown in FIG. 5A). Initially, PFOA peaks decrease in intensity until the PET-CD concentration reaches 0.1 g/L, at which point, the PFOA peaks become very broad and low in intensity. Resonance broadening can be a result of slow and intermediate chemical exchange as PFOA is interchanging between free and CD-associated states, and is typically characteristic of higher affinity interactions. When PFOA becomes associated with the CDs, the CDs transfer its shorter T₂, which results in signal broadening. Additionally, the non-uniform structure of CDs provides numerous different environments for association, potentially resulting in slightly different chemical shifts and broadened peaks as multiple PFOA molecules associate with varied sites on the CDs. As PEI-CD concentration increases beyond 0.1 g/L, new and shifted PFOA peaks appear; these new PFOA peaks continue to increase in intensity as PEI-CD concentration increases. The appearance of new PFOA peaks is consistent with a slow-intermediate chemical exchange regime, where peaks initially broaden but become sharp again in a concentration-dependent manner as the ratio of CD-associated PFOA increases.

As the concentration of PEI-CDs increases, simultaneously peak broadening was observed, decreases in peak height, and changes to chemical shifts (FIG. 3). This is not surprising due to the large size and non-uniform structure of CDs, resulting in shorter T₂ values for PFOA, and numerous sorption sites with multiple mechanisms of interaction and different affinities. Additionally, there are multiple environments for PFOA to exist within and in association with the PEI-CDs, resulting in a range of chemical shifts and potentially broadened peaks.

Based on the changes to the NMR spectra throughout the range of PEI-CD concentrations, we hypothesize the following pattern of sorption (FIG. 4 which is a Visual representation of how the PFOA solution is changing with increasing PEI-CD concentration based on the changes to NMR spectra. The blue and red rods represent PFOA, and the yellow circles represent PEI-CDs): Initially (1), there are many free PFOA molecules, and a decrease in peak height occurs as PFOA becomes associated with PEI-CDs; then at some point (2), all PFOA is associated with PEI-CDs, with many PFOA molecules on each CD, leading to shortened T₂ times, potentially many different microenvironments, and thus very broad and nearly undetectable PFOA peaks; and finally (3), as PEI-CD concentration increases further, there are less PFOA molecules per PEI-CD, and the PFOA is likely associating with sites that have higher affinity and more similar environments. At this point, new NMR features appear corresponding to the higher affinity environments and continue to grow with additional PEI-CDs.

Further interrogation of the NMR spectra in FIG. 3 reveals that the α-fluorine, which resides closest to the carboxylate group on PFOA, appears at −117.33 ppm with no PEI-CDs present, compared to −117.13 ppm with the highest PEI-CD concentration used. Changes in chemical shift are present across all fluorine atoms; however, the α-fluorine experiences the greatest change (See FIG. 5B for table showing the maximum change in chemical shift for each PFOA peak across the range of PEI-CD concentrations used in FIG. 3). This suggests that the chemical environment surrounding the α-fluorine changes the most, aligning with the idea that electrostatic interactions are a dominant sorption mechanism.

### Determining K_{D} Values

The disappearance and reappearance of PFOA peaks at new chemical shifts as PEI-CD concentration increases reveals critical information about free and bound PFOA. However, the absence of any titration points where peaks from both bound and free PFOA are simultaneously well-resolved indicates slow-intermediate exchange kinetics. It is possible that this is also a result of severe peak broadening brought about by numerous non-specific binding sites on PEI-CDs for PFOA and the many potential microenvironments PFOA could exist within. Unfortunately, there are no straightforward methods to model materials with multiple different binding sites, which can be assumed to be true for PEI-CDs. Thus, to quantify binding and affinity, methods commonly used for assessing ligand-protein interactions have been adapted, assuming a slow exchange regime.

The K_{D} values were extracted from binding curves using changes to PFOA peak integration or peak height and the mass ratios of PEI-CDs:PFOA. The first seven spectra from the top of FIG. 3 were used to build a binding curve, as the resonances in that CD concentration range (0 mg/L-0.1 g/L) corresponded to free PFOA. Binding curves were assembled for each fluorine group on PFOA to elucidate potential differences in affinity across the PFOA molecule and provide insight into binding orientations. Additionally, average peak height at each concentration point was used to assign a general K_{D} value for PFOA (FIG. 5C which shows a binding curve generated from the average height of all peaks in the first seven spectra of FIG. 3). The bound fraction (f_{b}) was estimated using peak intensity (peak integration or height) during the beginning titration points where free PFOA is disappearing (0.0 mg/L-100 mg/L PEI-CD) using:

$${f}_{b} = 1 - \frac{{I}_{free}}{{I}_{0}}$$

where I_{free} is the PFOA peak intensity at each titration point, and I₀ is PFOA peak intensity in the absence of PEI-CDs. The overall K_{D} value for PEI-CDs associating with PFOA is 10.1±3.4 mg/L using average peak height (FIG. 5C). Comparing calculated K_{D} values for each fluorine group reveals that the α-fluorine has the lowest K_{D} value, or highest affinity, when using either peak integration or peak height, 8.3±3.7 mg/L and 12.8±5.4 mg/L, respectively. The α-fluorine showing the highest affinity corresponds with it also having the greatest change in chemical shift (FIG. 5B), further suggesting electrostatic interactions as the primary mechanism of sorption.

To understand how PEI-CDs compare to other sorbent materials, we can use the overall K_{D} value of 10.1±3.4 mg/L to estimate percent removal of PFOA under various conditions and compare that performance to previously studied materials (Table 2). PEI-CDs show a competitive predicted percent removal of PFOA in comparison to other materials and perform much better than many well-established sorbent materials, such as granular and powdered activated carbons. Additionally, a higher percent removal is predicted for the PEI-CDs in comparison to PEI-functionalized cellulose microcrystals at 100 μg/L PFOA, which could be attributed to the higher surface area-to-volume ratio associated with nanoscale materials. Based on the K_{D} value 10.1 mg/L, a system contaminated with 1 μg/L of PFOA would need ˜134 mg/L of PEI-CDs to remove PFOA to levels below the USA EPA advisory concentration of 70 ng/L or ˜2.5 g/L of PEI-CDs to remove PFOA to below the newly proposed EPA maximum contaminant level of 4.0 ng/L. Assuming the current advisory concentration of 70 ng/L, it would cost ˜$0.37/gallon to remediate water contaminated with 1 μg/L of PFOA using PEI-CDs.

TABLE 2
Comparison between percent removal of PFOA by other sorbent
materials and the estimated percent removal by PEI-CDs based on
the estimated K_{D} value under varying conditions.

| | | | | | | Estimated PEI- | |
|---|---|---|---|---|---|---|---|
| | Material | | | | | CD % removal | |
| Material | conc. | | PFOA conc. | | % removal | (This work) | Reference |
| DEXSORB | 1 | μg/L | 10 | mg/L | ~10% | ~50% | ⁶ |
| DEXSORB+ | 1 | μg/L | 10 | mg/L | >99% | | |
| Amine-CDP | 1 | μg/L | 10 | mg/L | >99% | | |
| AE Resin | 1 | μg/L | 10 | mg/L | ~50% | | |
| PEI-f-CMC | 100 | μg/L | 50 | mg/L | ~65% | ~83% | ³² |
| Fe₃O₄ | 100 | mg/L | 500 | mg/L | ~60-80% | ~98% | ³⁸ |
| nanoparticles | | | | | | | |
| on GAC | | | | | | | |
| Granular | 100 | mg/L | 500 | mg/L | 55-60% | | |
| activated | | | | | | | |
| carbon | | | | | | | |
| (GAC) | | | | | | | |
| Powdered | 20 | mg/L | 1 | g/L | ~51% | >99% | ³⁹ |
| activated | | | | | | | |
| carbon (PAC) | | | | | | | |
| GAC | 5 | mg/L | 10 | g/L | 96% | >99% | ⁴⁰ |
| PAC | 5 | mg/L | 10 | g/L | >99% | | |
| PEI-CDs | 5 | mg/L | 100 | mg/L | 90% | — | This work |

### Time-Based ¹⁹F NMR Experiments

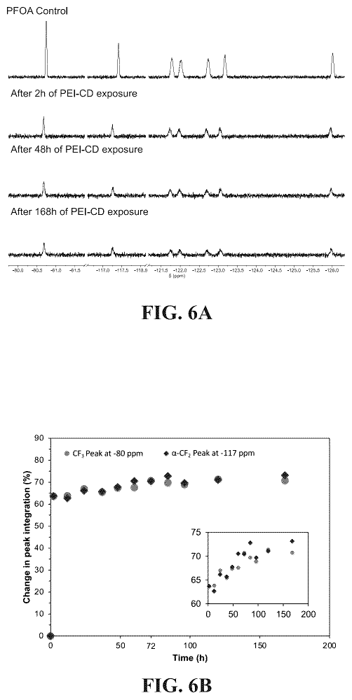

To understand the timescale of PEI-CD sorption of PFOA, we examined spectral changes to PFOA features over the course of one week at a single concentration of PEI-CDs and PFOA and compared them to the spectral features from the pure PFOA spectrum shown in FIG. 6 where (a) Selected ¹⁹F NMR spectra of PFOA at different timepoints after exposure to 100 mg/L of PEJ-CDs. (b) Corresponding change in peak integration at all time points compared to that without PEI-CDs for the CF₃ peak at −80.7 ppm and α-fluorine at −117.4 ppm. Inset shows a magnified version of the 2 h-168 h timepoints. The 72 h timepoint is noted with a vertical dashed line as that is when all other ¹⁹F NMR and characterization were conducted. By the end of the first 2 h of ID NMR acquisition, there was a 63% reduction in signal intensity for both the —CF₃ group and α-fluorine resonances in comparison to pure PFOA (FIG. 6B). After one week, the signal reduction increased to 73% and 70% for the —CF₃ group and α-fluorine resonances, respectively. Based on the changes in signal intensity, most sorption occurs within the first 2 h of exposure, with some additional sorption over the following 70 h, and no significant additional sorption for the remainder of the week. Importantly, there are no obvious signs of desorption over the course of the one-week timeframe. The temporal limitations with ¹⁹F NMR make it difficult to look at shorter timescales with the parameters used, and there is most likely significant information about the timescale of sorption that is unobservable in these experiments. Overall, this confirms that the 72 h timepoint used for kinetic studies and additional characterization is appropriate.

### Exposure to 24-PFAS Mixture

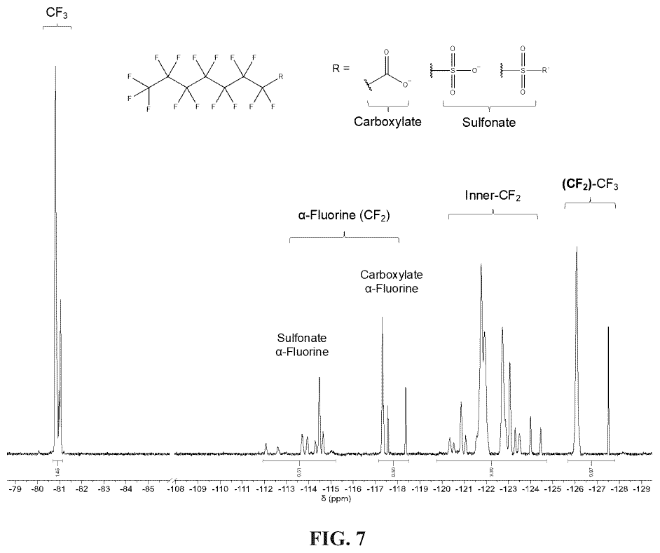

To further explore PEI-CDs as a potential sorbent material, ¹⁹F NMR experiments were conducted using a 24-PFAS mixture. The PFAS mixture includes those in US EPA Method 8327, which is relevant to surface water, groundwater, and wastewater matrices. The ¹⁹F NMR spectrum of the mixture was partially assigned based on previous ¹⁹F NMR studies (FIG. 7 which shows general peak assignments for 24-PFAS mixture). Regions corresponding to five different groups were identified: the CF₃ groups, carboxylate α-fluorines, sulfonate α-fluorines, the inner-CF₂, and CF₂ next to the CF₃. The ratios of integration values for the various regions correlated well to predicted ratios.

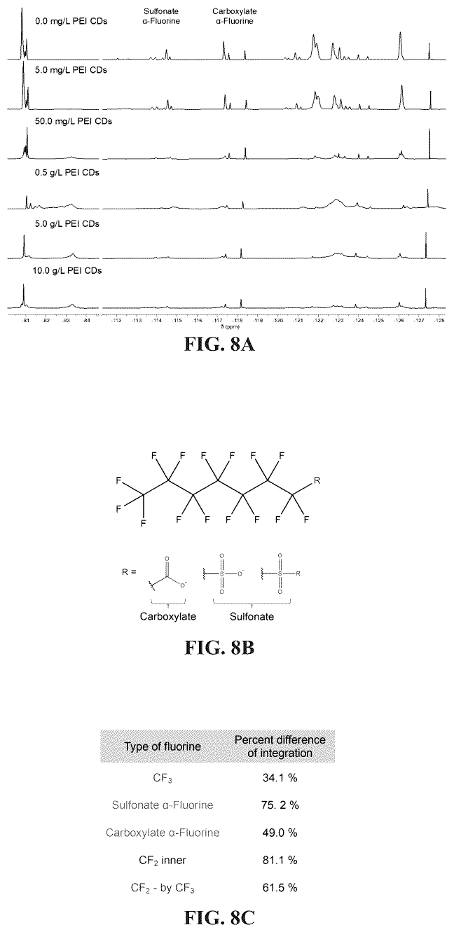

The PFAS mixture was exposed to increasing PET-CD concentrations, and spectral changes were monitored (See FIG. 8A showing 19F NMR spectra of a 24-PFAS mixture with each component at 5 mg/L and increasing amounts of PEI-CDs). Each PFAS in the mixture was set to the same concentration used in PFOA experiments, leading to 24 times the total PFAS amount. The lowest concentration of PEI-CDs used (5 mg/L) induced a slight decrease in peak intensities. At concentrations ≥50 mg/L PEI-CDs, the mixture spectra showed very apparent decreases in peak intensity, chemical shift changes, and peak broadening, indicating widespread sorption of PFAS. However, the peaks at −118.4 ppm and −127.4 ppm did not undergo any intensity or chemical shift changes throughout the titration. A comparison between the ¹⁹F NMR spectrum of neat perfluorobutanoic acid (PFBA) and the 24-PFAS mixture suggests these two peaks correspond to PFBA, the shortest chain PFAS in the mixture See FIG. 8B showing general structure corresponding to the different regions identified in FIG. 7.

To further illuminate differences in association among the components of the PFAS mixture, the percent difference of integration between the PFAS mixture control and the highest PEI-CD concentration (10.0 g/L) was calculated for the various fluorine groups (See FIG. 8C Showing percent difference in integration between the mixture control and incubation with 10 g/L PEI-CDs for the spectral regions and structural elements highlighted). The CF₃ group had the lowest percent difference, aligning with the hypothesis that the most likely mechanism of interaction is through electrostatics (far from the CF₃), leading to less changes in the CF₃ group environment and thus, less changes in intensity. Additionally, it is possible that the new broad peak at −83.3 ppm contributes significantly to CF₃ integration for the 10.0 g/L PEI-CD spectrum, leading to a lower percent difference. The sulfonate and carboxylate α-fluorine groups had 75.2% and 49.0% difference, respectively, suggesting that PEI-CD sorption was greater for perfluoroalkyl sulfonates in comparison to perfluoroalkyl carboxylates. This observation is consistent with previous studies that show the high affinity sulfonates have for various sorbent materials. The inner CF₂ chain has the highest percent difference in integration with 81.1%; it is possible PEI-CDs have greater affinity for longer chain molecules, leading to a greater difference in mid-PFOA integration. An affinity for longer chain molecules also corresponds with the minimal sorption observed for perfluorobutanoic acid, the shortest chain length in the mixture. This suggests PEI-CDs would be most effective for sorbing longer chain PFAS containing sulfonate groups.

### Results and Discussion for Chitosan-Based Carbon Dots

Chitosan-based CDs were synthesized using chitosan, lysine, and acid in different ratios and reaction conditions to change the surface charge of the nanoparticles (Table 3). Chitosan-based CDs synthesized with a microwave reactor had zeta potentials in the ranges of 15 mV-26 mV on average, while chitosan-based CDs synthesized in a round bottom flask at reflux have a zeta potential of 37 mV The sizes of particles according to DLS ranged from 55-130 nm, this is most likely an overestimate as hydrodynamic radii of CDs using DLS typically gives skewed result. TEM images of chitosan, acetic acid NPs show sizes closer to 30 nm.

TABLE 3
Summary of zeta potential and hydrodynamic radius from DLS of select CDs.

| Precursors | Conditions | Zeta (mV) | Average particle size (nm) |
|---|---|---|---|
| Chitosan, lysine, acetic acid 1:1:1 | 160° C./1 hr. | +15 | 130 |
| Chitosan, lysine, acetic acid | 150° C./1 hr. | +26 | 55 |
| 10:1:10 | | | |
| Chitosan, lysine, malic acid 1:1:1 | 150° C./1 hr. | +22 | 80 |
| Chitosan, acetic acid NPs | 48 h @ reflux | +37 | 105 |

Loading of PFAS into Chitosan-Based CDs

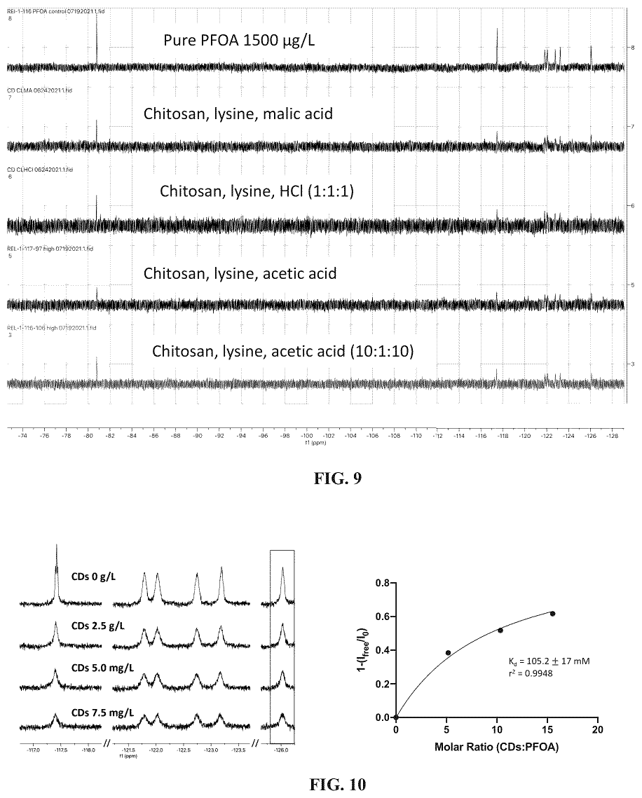

PFOA was chosen as the starting PFAS species to investigate chitosan-based CD affinity towards PFAS. CDs were exposed to PFOA, CD solution concentrations ranged from 1000 mg/L-7500 mg/L and PFAS concentrations ranged from 1.5 mg/L-5 mg/L. The CD/PFAS solutions were mixed on a shaker for 72 h, and 19F NMR was used to determine if CD uptake of PFAS occurred. Control solutions with just PFAS were used as a standard to compare against those with CDs. A decrease in PFAS signal from control solutions to CD/PFAS solutions indicated CD uptake of PFAS (FIG. 9). The changes to signal intensity with differing CD concentrations can be used to create a binding curve and compare PFAS affinity across the different CD species, as seen in FIG. 10.

### Conclusions

### PEI-Based Carbon Dots: Sorbent Material and Method for Probing CD-PFAS Interactions

Cationic PEI-based carbon dots were designed to sorb environmentally relevant PFAS species. Herein, ¹⁹F NMR is demonstrated to be an effective approach to assess association without using any additional sample purification steps. After exposure to PFOA, the PEI-CD effective size increased and ζ-potential decreased, suggesting cationic PEI-CDs sorb negatively charged PFOA. Sorption is further supported by changes to PFOA ¹⁹F NMR peak intensity and chemical shifts in the presence of PEI-CDs, both of which are reflective of slow-intermediate exchange kinetics. The peak corresponding to the α-fluorine on PFOA changes the most in intensity and chemical shift, suggesting electrostatic interactions are likely driving sorption. Time-based studies show most sorption occurs within the first 2 h of interaction, with no significant changes after 72 h. ¹⁹F NMR experiments with a 24-PFAS mixture show PEI-CDs associated with of a wide range of PFAS, with a potential preference towards perfluoroalkyl sulfonates and longer chain species. Overall, PEI-CDs prove to be an effective PFAS sorbent material, and ¹⁹F NMR is an effective method to screen for novel sorbent materials and help elucidate interaction mechanisms. These methods not only show a new category of sorbent materials, but also a platform for understanding what materials associate with PFAS and how.

### Carbon Dots for Phytoremediation of PFAS

The goal of this disclosure is to develop CDs with an affinity for PFAS that can enhance the PFAS phytoremediation. So far, chitosan-based CDs have been synthesized with different precursors and reaction conditions, and the hydrodynamic diameters and zeta potentials change as a function of precursor and reaction condition. Additionally, PEI-based CDs were synthesized with polyethyleneimine and citric acid. When the CDs were treated with PFOA, ¹⁹F NMR spectra suggested uptake of PFOA. Binding affinity was further quantified using the change in 19F NMR intensity of PFOA with varying CD concentrations. So far, the PEI-based CDs show the overall highest PFOA affinity. Out of the chitosan-based CDs, the chitosan, lysine, and malic acid CDs show the highest PFOA affinity. These results indicate the ability of CDs with certain precursors to absorb PFOA, which will be further applied in plant studies to develop an efficient method for PFAS phytoremediation.

### Methods

### Materials.

Chitosan (low molecular weight, Sigma-Aldrich), L-lysine (Sigma-Aldrich, ≥98.0%), citric acid (Sigma-Aldrich, 99.5%), polyethyleneimine (Alfa Aesar, branched, M.W. 10,000, 99%), perfluorooctanoic acid (Sigma-Aldrich, 95%), perfluorobutanoic acid (Sigma-Aldrich, >98%), trifluoroacetic acid-d (99.5 atom % D), and D₂O (Cambridge Isotopes), were used without further purification. DI water was from a Direct-Q® 3,5,8 laboratory water purification system by MilliporeSigma. The PFAS mixture was purchased as Native PFAS Reference Standard (M-8327-10X) from AccuStandard® containing 24 different components (Table S2).

### Synthesis.

PEI-based carbon dots (PEI-CDs) were synthesized using branched polyethyleneimine (1.0 g) and citric acid (0.25 g) dissolved in 10 mL of MQ H₂O in a CEM Discover® SP microwave reactor at 180° C. for 4 h (final pH=9). Chitosan-based CDs were synthesized with chitosan, lysine, and acid in weight ratios of 1:1:1, 5:1:5, 10:1:10, and 20:1:20 using a CEM Discover® SP microwave reactor and 0.1 g of chitosan in 10 mL H₂O. Acids used include HCl, malic acid, acetic acid, and citric acid. The temperature of the reaction used ranged from 150-200° C. with times ranging from 30 min to 2 h. These reactions were also conducted under reflux for 24-48 h without a microwave reactor. The products were filtered using a 0.2 μm regenerated cellulose syringe filter to remove bulk carbon residue and further purified with dialysis using Spectra/Por® 3 3.5 kD MWCO tubing for 72 h with water changes twice daily. The purified solution was lyophilized for 72 h to obtain a dried powder.

### Material Characterization of PEI-CDs and Chitosan-Based CDs.

The nanoparticle size distribution (DLS) and zeta potential of carbon dots were determined using Malvern Zetasizer Advance Pro Red. Fluorescence spectra were recorded with a PTI QuantaMaster 400 at an excitation wavelength of 350 nm using 5 nm slit widths from 360-600 nm.

### Per- and Polyfluorinated Alkyl Substance (PFAS) Exposure Experiments.

Dried PEI-CDs were resuspended in MQ water to make a 20 mg/mL stock solution for PFAS exposure experiments. Prior to any PFAS exposure experiments, the stock solution was sonicated for 15 min.

Dried chitosan-based CDs were resuspended in MQ water to make a 10 mg/mL stock solution for PFAS exposure experiments.

### Size, Charge, and Fluorescence for PEI-CDs

DLS and ζ-potential measurements were conducted on samples prepared with 100 mg/L PEI-CDs and 0 mg/L or 5 mg/L PFOA. The pH was adjusted to 4 using 0.1-0.4 M HCl and samples were left on a shaker for 72 h prior to DLS and ζ-potential measurements. Fluorescence measurements were conducted on samples containing PEI-CDs (500 mg/L) and PFOA (0, 1, 2.5, 5.0, and 7.5 mg/L). The pH was adjusted as above, and samples were left on a shaker for 72 h prior to acquiring the fluorescence spectra. Transmission electron microscopy was conducted using grids prepared with 3 mg/mL of PEI-CDs with a Thermo Fisher Talos F200X operating at 200 keV.

### Time-Based Experiments

Time-based experiments were conducted using 100 mg/L PEI-CDs with 5 mg/L PFOA. The pH of the sample was adjusted to 4 using 0.1-0.4 M HCl and immediately prepared for ¹⁹F NMR experiments. Spectra were recorded at 12 h increments for 4 days, then once a day until 1 week elapsed. The shortest time point possible is 2 h as that is the acquisition time. The sample remained in the NMR tube for the duration of the experiment. PFOA control spectra were recorded without any PEI-CDs at the beginning and end of experiment. The change in PFOA peak integration between the control and PEI-CD-containing solution at each time point was used to assess the timescale of the reaction and determine the best time point to conduct affinity studies.

### PFOA Affinity

Samples containing PEI-CDs (0, 0.1, 1, 5, 10, 50, 100, 500, 1000, 5000, and 10000 mg/L) and PFOA (5 mg/L) were prepared in glass scintillation vials with polyethylene caps. The pH was adjusted to 4 using 0.1-0.4 M HCl and samples were left on a shaker for 72 h ahead of spectral interrogation.

Samples containing chitosan-based CDs were prepared with CD concentrations ranging between 1000-7500 mg/L and PFOA concentrations ranging from 1.5-5 mg/L with total volumes between 1-5 mL. The pH was adjusted to 4 using 0.1-0.4 M HCl. PFOA solutions (1.5-5 mg/L) without CD treatment were used as negative controls. The solutions were placed in a shaker and incubated for >48 hours at room temperature.

### PFAS Mixture

For PFAS mixture experiments, samples were prepared to yield final concentrations of 0, 5, 50, 500, 5000, and 10000 mg/L PEI-CDs. The pH was adjusted to 4 using 0.1-0.4 M HCl. The PFAS mixture and pH adjusted PEI-CD solutions were combined to yield the listed PEI-CD concentrations and 5 mg/L of the PFAS mixture, where each of the 24 components were at 5 mg/L. pH adjustment was done prior to adding PFAS to minimize potential PFAS contamination to lab equipment. Samples were left on a shaker for 72 h ahead of spectral interrogation.

### ¹⁹F NMR Spectroscopy.

All NMR samples were prepared with 90% aqueous sample solution and 10% D₂O (90/10, v/v). A sealed capillary tube containing 50 μM trifluoroacetic acid-d was added to the NMR tube and used as a chemical shift reference (−75.51 ppm). ¹⁹F NMR spectra were acquired at 564 MHz on a Bruker 600-MHz Avance NEO with a 5 mm triple resonance cryoprobe without proton decoupling. A delay time of 8 s and 1024 scans were experimentally determined to give sufficient signal-to-noise ratio and complete longitudinal relaxation.

Spectral processing was done using MestReNova. Each spectrum was phase corrected, baselined (Whittaker Smoother), and referenced to TFA at −75.51 ppm. Integration, chemical shift, and peak height were recorded for each fluorine peak of PFOA at all PEI-CDs and chitosan-based CD concentrations. As CD concentration increased, the concentration of CD-bound PFOA increased, resulting in changes to the ¹⁹F NMR signal. The observed signal intensity change can be assumed to be relatively proportional to the fraction bound (f_{b}) of PFOA as: f_{b}=1−f_{f}=1−I_{free}/I₀=[PFOA-CD]/[PFOA], where [PFOA] is the total concentration of PFOA and [PFOA-CD] is the concentration of CD-bound PFOA. I_{free} is the PFOA NMR signal of free PFOA at each PEI-CD concentration point, and I₀ is the signal of PFOA without CDs present. Binding curves were created for each fluorine atom on PFOA using the approximation of the fraction bound (1−I_{free}/I₀) based on integration values and peak height versus mass ratio (M) of CD:PFOA. Additionally, the average peak height across all 7 peaks was used to determine an average approximate binding curve. Approximate K_{D} values were obtained by a non-linear best fit using GraphPad Prism 8 using the following equation:

$${f}_{b} = 1 - \frac{{I}_{free}}{{I}_{0}} = 0.5 * ( M + 1 + \frac{{K}_{D}}{[ PFOA ]} - \sqrt{{( M + 1 + \frac{{K}_{D}}{[ PFOA ]} )}^{2} - 4 M )}$$

1. A method of producing nanoscale carbon dots for use by a plant to produce increased affinity by the plant for anionic per- and poly-fluoroalkyl substances, the method comprising:
synthesizing the nanoscale carbon dots through a hydrothermal reaction of branched polyethyleneimine and citric acid in a microwave reactor producing polyethyleneimine-based carbon dots.

2. The method of claim 1 wherein the nanoscale carbon dots were synthesized in a microwave reactor.

3. The method of claim 1 wherein the nanoscale carbon dots were synthesized at a temperature range of approximately 150 to 200° C.

4. A polyethyleneimine-based carbon dot with increased affinity for anionic per- and poly-fluoroalkyl substances, the carbon dot being produced through a hydrothermal reaction of branched polyethyleneimine and citric acid producing polyethyleneimine-based carbon dots.

5. The polyethyleneimine-based carbon dot of claim 4 wherein the hydrothermal reaction occurred in a microwave.

6. The polyethyleneimine-based carbon dot of claim 5 wherein the hydrothermal reaction occurred at a temperature range of approximately 150 to 200° C.

7. The method of claim 1 and further comprising:
synthesizing the nanoscale carbon dots through a hydrothermal reaction of chitosan, lysine, and an acid in a microwave reactor producing chitosan-based carbon dots.

8. The method of claim 7 wherein the acid comprises HCl, malic acid, citric acid, or acetic acid or any combination thereof.

9. The method of claim 7 wherein the nanoscale carbon dots were synthesized with chitosan, lysine, and acid in weight ratios of approximately 1:1:1 or 5:1:5 or 10:1:10 or 20:1:20.

10. The method of claim 7 wherein the nanoscale carbon dots were synthesized in a microwave reactor.

11. The method of claim 7 wherein the nanoscale carbon dots were synthesized from about 30 minutes to 2 hours.

12. The method of claim 7 wherein the nanoscale carbon dots were synthesized under reflux for 48 hours.

13. A chitosan-based carbon dot with increased affinity for anionic per- and poly-fluoroalkyl substances, the carbon dot being produced through a hydrothermal reaction of chitosan, lysine, and an acid producing chitosan-based carbon dots.

14. The chitosan-based carbon dot of claim 13 wherein the acid comprises HCl, malic acid, citric acid, or acetic acid or any combination thereof.

15. The chitosan-based carbon dot of claim 13 wherein the nanoscale carbon dots were synthesized with chitosan, lysine, and acid in weight ratios of approximately 1:1:1 or 5:1:5 or 10:1:10 or 20:1:20.

16. The chitosan-based carbon dot of claim 13 wherein the nanoscale carbon dots were synthesized in a microwave reactor.

17. The chitosan-based carbon dot of claim 13 wherein the nanoscale carbon dots were synthesized from about 30 minutes to 2 hours.

18. The chitosan-based carbon dot of claim 13 wherein the nanoscale carbon dots were synthesized under reflux for 48 hours.
